(19) United States
(12) Patent Application Publication
(10) Pub. No.: US 2010/0053032 A1
(43) Pub. Date: Mar. 4, 2010

(54) Touch detecting circuit for bistable electronic display

(75) Inventor: Hui-Lung Lai, Tainan County (TW)

Correspondence Address: BACON & THOMAS, PLLC, 625 SLATERS LANE, FOURTH FLOOR, ALEXANDRIA, VA, 22314-1176, US

(73) Assignee: CHI HSIN ELECTRONICS CORP., Tainan County (TW)

(21) Appl. No.: 12/230,205

(22) Filed: Aug. 26, 2008

(51) Int. Cl. G09G 3/00

(52) U.S. Cl. 345/30

(57) ABSTRACT

A touch detecting circuit of the present invention is provided between a substrate and a bistable display film of a display. The touch detecting circuit includes a plurality of first electrodes along a first direction, a plurality of second electrodes along a second direction, and an insulating layer between the first electrodes and the second electrodes. The insulating layer has through holes, on opposite ends of which the first electrodes and the second electrodes are provided. Each of the second electrodes has a contact terminal not masking the entire through hole. The first electrodes will contact the second electrodes under an external force exertion and a resistance effect will occur to let the system terminal of the display detecting the location of the external force.

### BACKGROUND OF THE INVENTION

1. Field of the Invention

The present invention relates to an optical display and more particularly, to a touch detecting circuit for a bistable electronic display.

2. Description of the Related Art

E-paper displays are provided to simulate the real papers with inked words or pictures. The E-paper display has many characters including better readability, portability, reusability, and download for update. The E-paper display needs power only when changing the picture. In other words, the power is off when reader reads the picture on the E-paper display that would reduce the power consumption thereof. Besides, there is no a backlight module in the E-paper display. The E-paper display is readable in a light environment that the cost thereof is lower.

The E-paper displays have many advantages that the conventional books don't have. However, readers have to operate the keys thereon to turn pages that is inconvenient. Some E-paper displays are provided with a touch panel for a better operation. Such touch panel is stacked on the top of the E-paper display, and the touch panel has a glass substrate and other elements that such E-paper display is thicker and heavier. The drawbacks as described above may affect the displaying performance of the E-paper displays. We strongly believe that the E-paper display will have a wider application when above drawbacks are fixed.

### SUMMARY OF THE INVENTION

The primary objective of the present invention is to provide a touch detecting circuit for a bistable electronic display, which is built in the display and will not increase the thickness and the weight of the display, furthermore, it will not affect the displaying performance of the display.

The secondary objective of the present invention is to provide a touch detecting circuit for a bistable electronic display, which has a better touch function.

To achieve the objectives of the present invention, a touch detecting circuit of the present invention is provided between a substrate and a bistable display film of a display. The touch detecting circuit includes a plurality of first electrodes along a first direction, an insulating layer, and a plurality of second electrodes along a second direction. Each of the first electrodes has at least a first contact area. The insulating layer has through holes associated with the first contact areas of the first electrodes. The insulating layer is between the first electrodes and the second electrodes. Each of the second electrodes has a contact terminal not masking the entire through hole. The contact terminal has a second contact area, which keeps a distance from the corresponding first contact area.

### BRIEF DESCRIPTION OF THE DRAWINGS

FIG. 1 is a sectional view in a part of a preferred embodiment of the present invention;

FIG. 2 is a sectional view of the preferred embodiment of the present invention;

FIG. 3 is a sectional view along the 3-3 line of FIG. 2;

FIG. 4 is a sectional view along the 4-4 line of FIG. 2;

FIG. 5 is similar to FIG. 3, showing the vertical second electrode;

FIG. 6 is similar to FIG. 3, showing the second electrode having the recess portion and the protrusion on a position corresponding to the through hole;

FIG. 7 is similar to FIG. 3, showing the flat layer on the second electrode and the insulating layer;

FIG. 8 is similar to FIG. 2, showing a plurality of electrodes in electrical connection together and connected to the system terminal of the display;

FIG. 9 is similar to FIG. 2, showing the odd electrodes connected to the system terminal of the display; and

FIG. 10 is an enlarged view in a part of the preferred embodiment of the present invention, showing the second electrode having the recess portion in communication with the trough hole of the insulating layer.

### DETAILED DESCRIPTION OF THE INVENTION

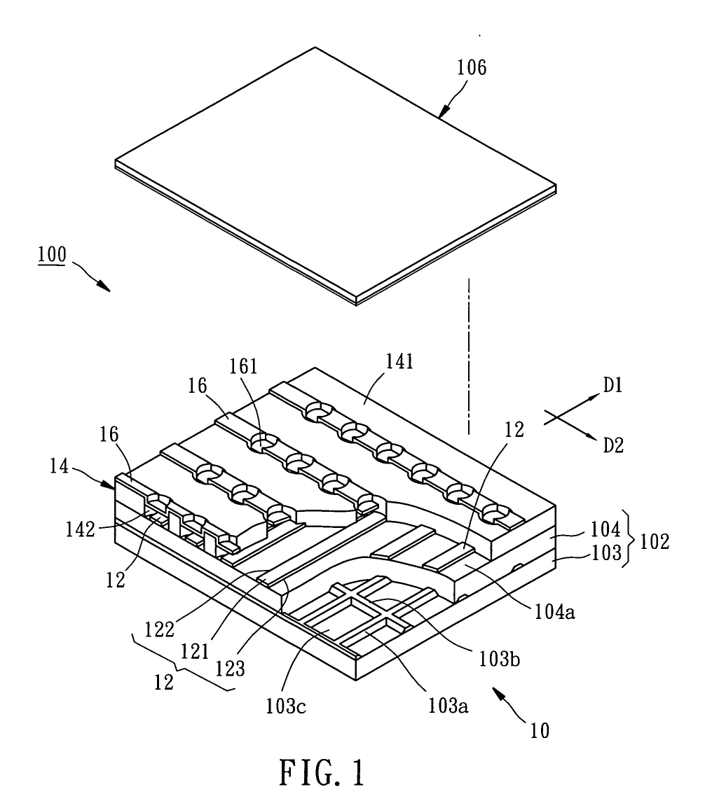

FIGS. 1˜4 show a touch detecting circuit 10 of a bistable electronic display 100. The display 100 has a substrate 102 and a bistable display film 106. The substrate 102, which constructs a bottom portion of the display 100, has a thin film transistor array substrate 103 having a plurality of data lines 103a and scan lines 103b, and a surface layer 104. The surface layer 104 is made of an insulating material to cover the data lines 103a and the scan lines 103b. The surface layer 104 has a flat surface 104a. The bistable display film 106, which constructs a top portion of the display 100, changes pictures shown thereon by an electric field. The display 100 further includes a system terminal 107 to detect and determine pressed positions of the touch detecting circuit 10. The touch detecting circuit 10 of the preferred embodiment of the present invention is described in following:

The touch detecting circuit 10, which is provided between the substrate 102 and the bistable display film 106, includes a plurality of first electrodes 102, an insulating layer 14, and a plurality of second electrodes 16.

The first electrodes 12 are provided on the surface 104a of the surface layer 104 along a first direction D1, each of which has a top side 121 higher than the surface 104a, and long lateral sides 122 and 123 adjacent to the top side 121. In the present embodiment, each of the first electrodes 12 are electrically connected to the system terminal 107.

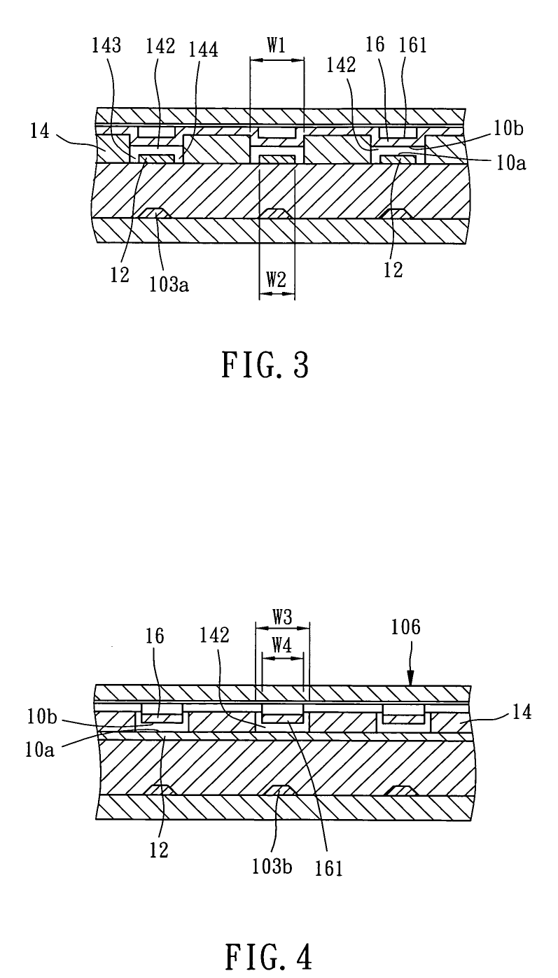

After the first electrodes 12 are made, the insulating layer 14 covers all of the first electrodes 12. The insulating layer 14 has a top side 141 and a plurality of transverse through holes 142. In the present embodiment, one first electrode 12 is associated with plural of the through holes 142. As shown in FIG. 1 and FIG. 3, each of the through holes has an opening end along a second direction D2 having an opening with a width W1 greater than widths W2 of the first electrodes 12 along the second direction D2. With this definition, each of the top sides 121 of the first electrodes 12 has first contact areas 10a aligned with the through holes 142 respectively. Besides, there are gaps 143 and 144 between an inner sidewall of each through holes 142 and the long lateral sides 122 and 123 of each first electrode 12.

After the insulating layer 14 is made, insulating support pads (not shown) are provided in the through holes 142 of the insulating layer 14. The support pads cover the first electrodes 12 in the through holes 142. The support pads are conventional devices, so we do not describe the detail here. After that, a metal foil is deposited on the top side 141 of the insulating layer 14, and is performed with photo resistor coating, exposure, development, and etching to make the second electrodes 16. The second electrodes 16, which are parallel and along the second direction D2 orthogonal to the first direction D1, are electrically connected to the system terminal 107 respectively. In above process, the top side 141 of the insulating layer 14 is higher than the support pads so that each of the second electrodes 16 forms contact terminals 161 in the through holes 142. In the present preferred embodiment, the contact terminals 161 are U-shaped. As shown in FIG. 4, each of the through holes 142 of the insulating layer 16 of the present embodiment has an opening along the first direction D1 having a width W3 greater than a width W4 of the contact terminal 161 of each second electrode 16 along the first direction D1. This is convenient for removal of the support pads. After the support pads are removed, each of the contact terminals 161 is suspended to form a second contact area 10b facing the first electrode 12. There is a distance between each of the second contact areas 10b and the corresponding first contact area 10a.

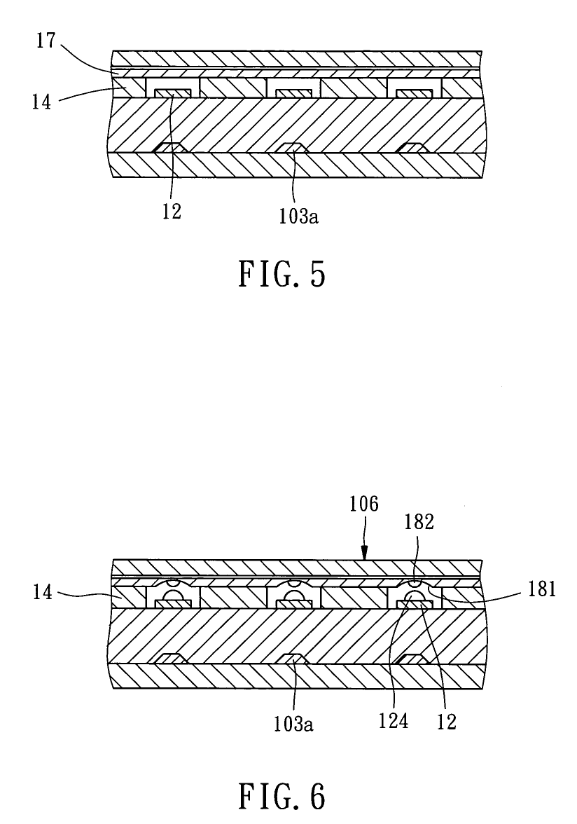

FIG. 5 shows a vertical second electrode 17 because that the support pads are even with the top side 141 of the insulating layer 14. When the support pads are higher than the top side 141 of the insulating layer 14, it will get second electrodes 18 having recess portions 181 as shown in FIG. 6. To enhance the contact between the electrodes, as shown in FIG. 6, it may provide a protrusion 182 projected from a bottom of the recess portion 181 and a protrusion 124 on the first electrode 12 associated with the protrusion 182.

In above embodiment, when one presses the bistable display film 106, the pressing force will deform the contact terminal 161 of the second electrode 16 thereunder that the second contact area 10b touches the corresponding first contact area 10a and a resistance effect is occurred. In this time, the system terminal 107 will identify the location of the pressing force immediately according to the change of current resistance for the following operation.

With the description above, the touch detecting circuit 10 of the present invention is built in the display 100 that fixes the problem of thicker and heavier of the conventional device with a touch panel. The present invention has no effect on the optical display performance of the bistable display film 106. In addition, the present invention provides the gaps 143 and 144 between the first electrodes 12 and the inner sidewalls of the through holes 142 to prevent the edges of the through holes 142 from crashing because of the pressure to keep a well touch sensing relation between the first contact areas 10a and the second contact areas 10b.

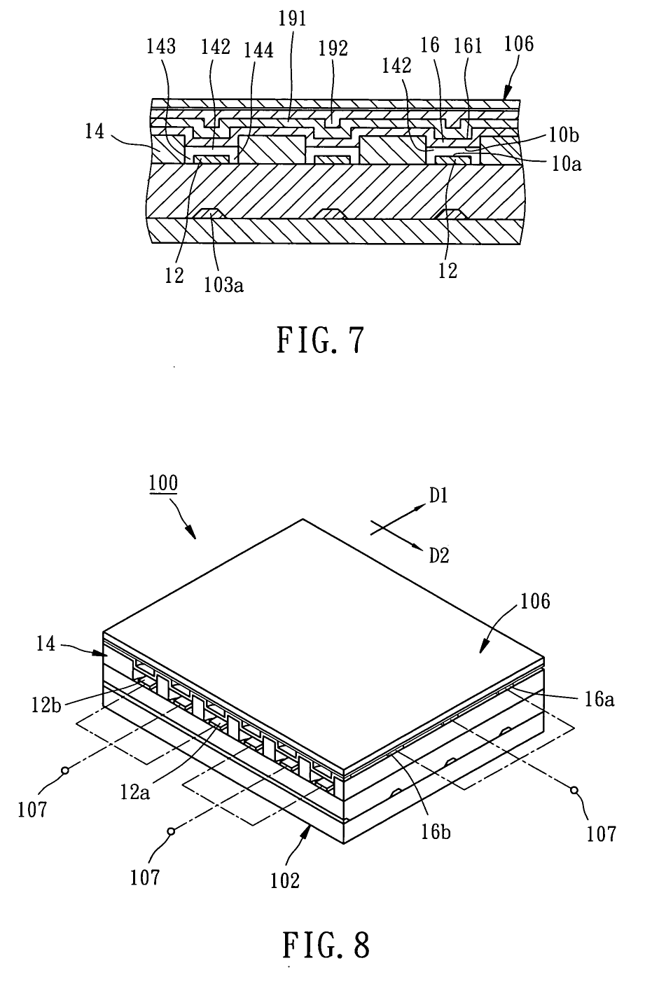

In addition, the first electrodes 12 of the present invention are right on the tops of the corresponding data lines 103a, and the second electrodes 16 are right on the tops of the corresponding scan lines 103b. However, they can be made on a pixel area 103c constructed by the orthogonal data lines 103a and the scan lines 103b. Besides, it is not necessary for the through holes 142 of the insulating layer 14 having to be associated with each of the first electrodes 12. For example, the first line of the through holes 142 is on the top of the first of the first electrodes 12, and the second line of the through holes 142 is on the top of the third of the first electrodes 12. In addition, to enhance the lamination of the bistable display film 106, the present invention may provide a covering layer 191, which is made of an insulating material, on the second electrodes 16, as shown in FIG. 7, and then provide a flat layer 192 on the covering layer 191 to enhance the lamination of the bistable display film 106.

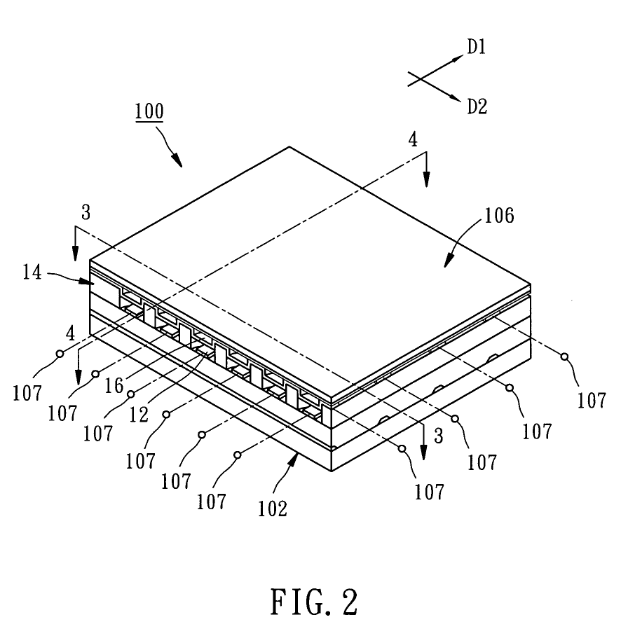

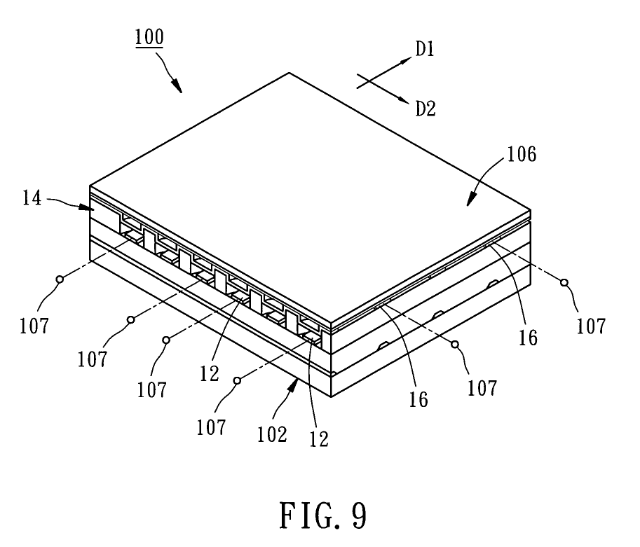

Besides the first electrodes 12 and the second electrodes 14 may be electrically connected to the system terminal 107 respectively, they may be divided into groups. As shown in FIG. 8, the electrodes in the same group are electrical connected together first, and then connected to the system terminal 107. It is mentioned that in each of the groups, a distance from the first to the last of the first (second) electrode 12a(12b) is less than or identical to 0.7 cm. This is because that the electrodes are very fine, and it is about 0.7 cm when a tip of finger touches the electrodes, so that the groups may provide the system terminal 107 sensing the correct touching position. In addition, the connection of the electrodes and the system terminal 107 may be done as shown in FIG. 9 which only odd electrodes 12 are connected to the system terminal 107. There may be two or more electrodes not connected to the system terminal 107 between the electrodes 12 connected to system terminal 107. However, a distance of the distribution of the electrodes 12 should be less than 0.7 cm for the correct position sensing. Referring to FIG. 2, a distance between the neighboring first electrodes 12 and the neighboring second electrodes 16 should be less than 0.7 cm also for the condition of touching by finger. On contrary, in the condition of touching by pen, the distance between the neighboring first electrodes 12 (or the neighboring second electrodes 16) should be narrower.

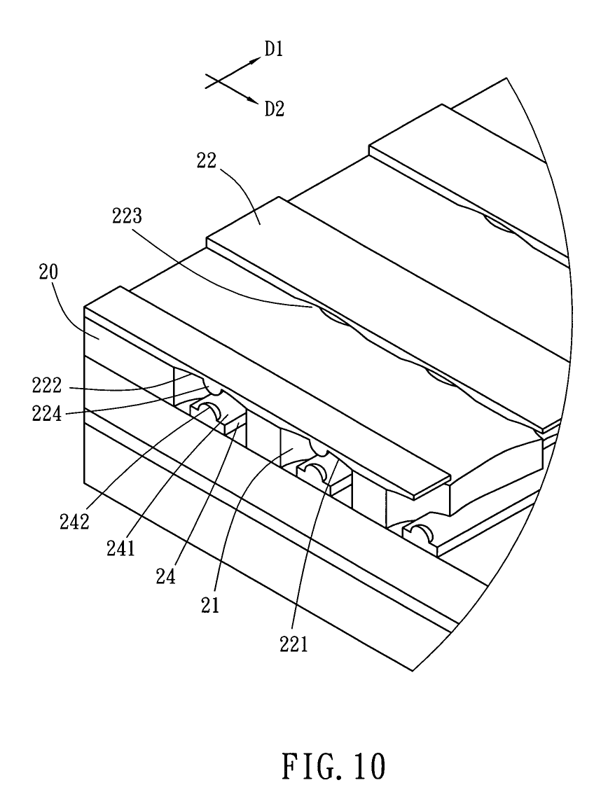

In the embodiments as described above, widths of the second contact areas of the second electrodes along the first direction are less than that of the through holes of the insulating layer along the first direction. This character makes it easier to clean the support pads made of insulating material. There are some other ways to achieve the above objective. For example, referring to FIG. 10, widths of the through holes 21 of the insulating layer 20 along the first direction D1 are less than that of the contact areas 221 of the second electrodes 22 along the first direction D1. Furthermore, each of the second electrodes 22 has a recess portion 222 associated with the through holes 21 and two gaps 223 on opposite sides of the recess portion 222 communicated with outside that also may help the step of cleaning the support pads. The second electrode 22 is provided with a protrusion 224 on a bottom side of the recess portion 222, and the first electrode 24 is provided with a protrusion 242 on the first contact area 241 to enhance the contact of the electrodes.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A touch detecting circuit for a bistable electronic display, which the display includes a substrate and a bistable display film on the substrate, and touch detecting circuit is provided between the substrate and the bistable display film, comprising:
a plurality of first electrodes along a first direction, each of which has at least a first contact area on a top thereof;
an insulating layer, which is provided between said first electrodes and the bistable display film, having a plurality of through holes associated with said first contact areas of said first electrodes respectively; and
a plurality of second electrodes, which is provided between said insulating layer and the bistable display film, along a second direction crossing said first direction, wherein each of said second electrodes has contact terminals associated with said through holes, and each of said contact terminals, which does not mask said entire through hole, has a second contact area keeping a predetermined distance from said corresponding first contact area of said first electrode.

2. The touch detecting circuit as claimed in claim 1, wherein said insulating layer has a top side, on which said second electrodes are provided, and widths of said through holes of said insulating layer are greater than that of said second contact areas of said second electrodes.

3. The touch detecting circuit as claimed in claim 2, wherein said contact terminals of said second electrodes are received in said through holes of said insulating layer respectively.

4. The touch detecting circuit as claimed in claim 2, wherein each of said second electrodes has a recess portion on said contact terminal associated with said through hole.

5. The touch detecting circuit as claimed in claim 4, wherein each of said second electrodes has a protrusion on a bottom side of said recess portion of said contact terminal.

6. The touch detecting circuit as claimed in claim 5, wherein each of said first electrodes has a protrusion on said first contact area associated with said protrusions of said second electrodes respectively.

7. The touch detecting circuit as claimed in claim 1, wherein said insulating layer has a top side, on which said second electrodes are provided, and widths of said through holes of said insulating layer are less than that of said second contact areas of said second electrodes, and each of said second electrodes has at least a gap communicated with said through hole of said insulating layer.

8. The touch detecting circuit as claimed in claim 7, wherein each of said second electrodes has a recess portion, beside which said gap is provided, on a side facing said through hole and a protrusion on a bottom side of said recess portion associated with said first contact area of said first electrode.

9. The touch detecting circuit as claimed in claim 8, wherein each of said first electrodes has a protrusion on said first contact area associated with said protrusions of said second electrodes respectively.

10. The touch detecting circuit as claimed in claim 1, wherein said first direction is orthogonal to said second direction, and widths of said through holes of said insulating layer along said second direction are less than that of said first contact areas of said first electrodes along said second direction.

11. The touch detecting circuit as claimed in claim 10, wherein the substrate of the display has a surface layer, on which said first electrodes are provided and projected therefrom, and each of said first electrodes has two long lateral sides, and said insulating layer masks said first electrodes, and there is a gap between each of said long lateral sides of said first electrodes and a sidewall of each of said through holes of said insulating layer respectively.

12. The touch detecting circuit as claimed in claim 1, wherein said first electrodes are divided into several groups, in each of which a distance from the first to the last of said first electrodes is less than or identical to 0.7 cm.

13. The touch detecting circuit as claimed in claim 1, wherein said second electrodes are divided into several groups, in each of which a distance from the first to the last of said second electrodes is less than or identical to 0.7 cm.

14. The touch detecting circuit as claimed in claim 1, wherein a distance between said neighboring first electrodes is less than or identical to 0.7 cm.

15. The touch detecting circuit as claimed in claim 1, wherein a distance between said neighboring second electrodes is less than or identical to 0.7 cm.

16. The touch detecting circuit as claimed in claim 1, wherein said first electrodes are divided into several groups, in each of which said first electrodes are electrically connected together, and a distance from the first to the last of said first electrodes is less than or identical to 0.7 cm.

17. The touch detecting circuit as claimed in claim 1, wherein said second electrodes are divided into several groups, in each of which said second electrodes are electrically connected together, and a distance from the first to the last of said second electrodes is less than or identical to 0.7 cm.

18. The touch detecting circuit as claimed in claim 1, further comprising a covering layer, which is made of an insulating material, covering said second electrodes and a flat layer between said covering layer and the bistable display film.
